(19) United States
(12) Patent Application Publication
(10) Pub. No.: US 2026/0339245 A1
(43) Pub. Date: Oct. 29, 2026

(54) FIXING DEVICE AND IMAGE FORMING APPARATUS

(71) Applicant: CANON KABUSHIKI KAISHA, Tokyo (JP)

(72) Inventors: HIROSHI MIYAMOTO, Saitama (JP); SUGURU TAKEUCHI, Chiba (JP); YASUHARU TORATANI, Chiba (JP); KIYONORI SOTOME, Ibaraki (JP); MASAKI SUDA, Chiba (JP)

(21) Appl. No.: 19/546,592

(22) Filed: Feb. 23, 2026

(30) Foreign Application Priority Data
Apr. 26, 2025 (JP) 2025-073789

(51) Int. Cl. G03G 15/20

(52) U.S. Cl. CPC G03G 15/2053; G03G 15/205; G03G 15/2064; G03G 2215/2038

(57) ABSTRACT

A fixing device includes an endless belt, a heating roller, a pressing roller, a nip forming member and a supporting member. The heating roller is disposed in an inner peripheral surface of the belt and heats the belt by a first heater. The pressing roller is in contact with an outer peripheral surface of the belt and nips and conveys the recording material. The supporting member supports the nip forming member. A second heater heats the supporting member. A controller causes the first heater and the second heater to generate heat in a start up period of the fixing device and causes the first heater to generate the heat and the second heater not to generate the heat in a fixing period of performing a fixing operation.

### BACKGROUND

### Field of the Technology

The present invention relates to a fixing device which heats a toner image on a recording material, and an image forming apparatus using an electrophotographic type or an electrostatic recording type such as a copying machine, a printer, and a facsimile device or a multifunction machine provided with a plurality of functions of these, which is provided with the fixing device.

### Description of the Related Art

In an image forming apparatus such as a copy machine using an electrophotographic type or an electrostatic recording type, forming a toner image on a recording material having a sheet shape, and fixing the toner image on the recording material onto the recording material by heating and pressing the toner image with a fixing device (fixing operation) are performed.

As the fixing device, for example, a configuration using a fixing belt constituted by an endless belt as a fixing member (rotatable heating member) which heats the toner image on the recording material (belt fixing device, belt heating type) is known.

In Japanese Patent Application Laid-Open No. 2013-156334, a fixing device including a fixing belt (heating belt) as a fixing member, a fixing pad as a heating member which contacts an inner peripheral surface of the fixing belt, and a heating source which heats the fixing pad is described. In addition, this fixing device includes a heating roller (heating roll) as a heating member contacting the inner peripheral surface of the fixing belt and a heating source which heats the heating roller. Further, this fixing device includes a pressing roller (pressing roll) which forms a fixing nip portion by pressing the fixing belt from an outer peripheral surface side thereof against the fixing pad. And by heating the fixing belt using the fixing pad and the heating roller, and by nipping and conveying the recording material, which bears an unfixed toner image, in the fixing nip portion, this fixing device fixes the toner image onto the recording material with heat and pressure.

### SUMMARY

According to an aspect of the present invention, there is provided a fixing device for fixing a toner image onto a recording material, the fixing device comprising: an endless belt; a heating roller disposed in an inner peripheral surface side of the belt and configured to heat the belt by a first heater provided therein; a pressing roller in contact with an outer peripheral surface of the belt and configured to nip and convey the recording material; a nip forming member disposed opposed to the pressing roller across the belt and configured to form a fixing nip portion; a supporting member configured to support the nip forming member; a second heater configured to heat the supporting member; and a controller configured to control the first heater and the second heater, wherein the fixing device has a start up period until the fixing device becomes a fixable state and a fixing period of performing a fixing operation, and wherein the controller causes the first heater and the second heater to generate heat in the start up period and causes the first heater to generate the heat and the second heater not to generate the heat in the fixing period.

Further features of the present invention will become apparent from the following description of exemplary embodiments with reference to the attached drawings.

### BRIEF DESCRIPTION OF THE DRAWINGS

FIG. 1 is a cross-sectional view illustrating an outline configuration of an image forming apparatus.

FIG. 2 is a cross-sectional view illustrating an outline configuration of a fixing device.

FIG. 3 is a block diagram illustrating a control configuration of the image forming apparatus.

FIG. 4 is a graph view showing an example of transition of a temperature of each member of the fixing device and transitions of power consumption of heating sources.

FIG. 5A is a graph view showing a study result of the power consumption of the heating source of the fixing device (Comparative Example).

FIG. 5B is a graph view showing a study result of the power consumption of the heating source of the fixing device (Comparative Example).

FIG. 5C is a graph view showing a study result of the power consumption of the heating source of the fixing device (Embodiment).

FIG. 6 is a flowchart diagram of control of a heater inside a stay.

FIG. 7 is an explanatory view for describing classification of states of the fixing device.

FIG. 8 is a schematic view for describing transition between the states of the fixing device.

### DESCRIPTION OF THE EMBODIMENTS

Hereinafter, a fixing device and an image forming apparatus according to the present invention will be described in more detail with reference to the drawings.

### Embodiment 1

### <Configuration of an Image Forming Apparatus>

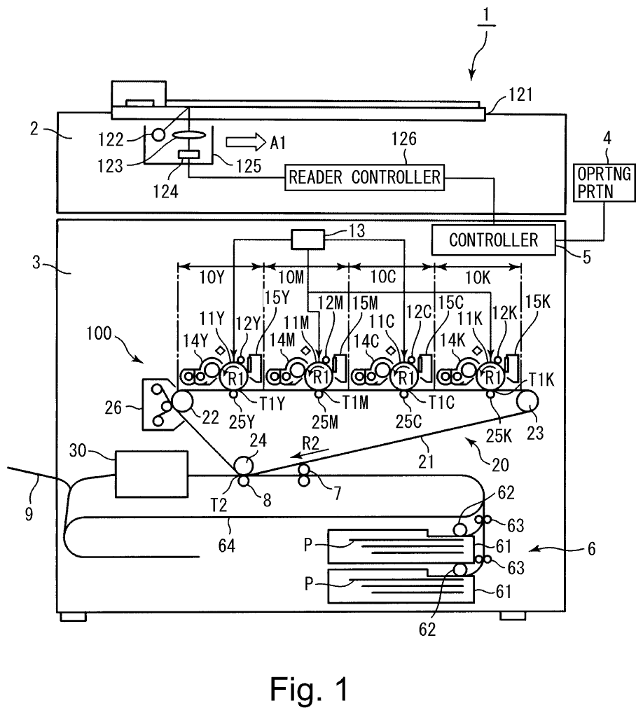

First, a configuration of an image forming apparatus in the present Embodiment will be described. FIG. 1 is a cross-sectional view illustrating an outline configuration of an image forming apparatus 1 in the present Embodiment. In the present Embodiment, the image forming apparatus 1 is an image forming apparatus of tandem type employing an intermediary transfer type, which is capable of forming a full-color image on a recording material P having a sheet shape using an electrophotographic type.

Incidentally, as to the image forming apparatus 1 and elements thereof, a front side of a paper of FIG. 1 is defined as a “front (front surface)” side, and a back side of the paper of FIG. 1 is defined as a “rear (back surface)” side. A direction perpendicular to the paper of FIG. 1 connecting the front side and the rear side of the image forming apparatus 1 (front-rear direction) is assumed to be approximately parallel to a rotational axis direction of a photosensitive drum 11, which will be described below. In addition, as the recording material (recording medium, transfer material, sheet) on which the image is formed in the image forming apparatus 1, paper is typically used. Therefore, here, the recording material is sometimes referred to as a “paper”, a “sheet”, etc. However, the recording material is not limited to paper, but may be material formed of material other than paper such as a plastic sheet or material including material other than paper. In addition, a type of the recording material (paper type) includes arbitrary information, with which the recording material is distinguishable, such as an attribute based on a general characteristic such as a plain paper, a coated paper, a thick paper, and a synthetic paper (so-called, paper type category), a numerical value and/or a numerical value range such as a basis weight and a thickness, and a brand (including a maker, a product number, etc.). Generally, the type of the recording material is often specified by the paper type category and the thickness (or the basis weight).

The image forming apparatus 1 includes an image reading portion (reader portion) 2 and a printer portion (image forming apparatus main assembly) 3. The image reading portion 2 reads an original placed on an original table glass 121. The image reading portion 2 includes an optical system unit 125 provided with a light source 122, an optical system member 123 such as a lens, and a CCD sensor 124. In the optical system unit 125, light irradiated from the light source 122 is reflected by the original, and forms an image on the CCD sensor 124 via the optical system member 123 such as the lens. The optical system unit 125 in this manner converts the original, by being moved in a direction of an arrow A1 in FIG. 1 and scanning the original, into an electric signal data sequence for each line. An image signal obtained by the CCD sensor 124 is sent, via a reader control portion 126, to a control portion 5 provided in the printer portion 3. And in the control portion 5, to this image signal, image processing adapted to an image forming portion 100, which will be described below, is performed. In addition, as the image signal, the control portion 5 may also receive an external input from an external host device such as a print server (for example, a personal computer).

The printer portion 3 includes, as a plurality of image forming units, four image forming units 10Y, 10M, 10C, and 10K which form images of a yellow color (Y), a magenta color (M), a cyan color (C), and a black color (K), respectively. Incidentally, elements having the same or corresponding functions or configurations, which are provided for each color, may be described collectively by omitting Y, M, C and K at the ends of reference numerals indicating that the element is for either one of the colors. The image forming unit 10 is constituted by a photosensitive drum 11 (11Y, 11M, 11C, 11K), which will be described below, a charging roller 12 (12Y, 12M, 12C, 12K), an exposure device 13, a developing device 14 (14Y, 14M, 14C, 14K), a drum cleaning device 15 (15Y, 15M, 15C, 15K), etc. In the present Embodiment, the exposure device 13 is configured as one unit which irradiates the photosensitive drum 11 in each image forming unit 10 with light. However, the exposure device 13 may be provided independently for each image forming unit 10. In each image forming unit 10, image formation is performed based on the image signal described above.

The photosensitive drum 11, which is a photosensitive member (electrophotographic photosensitive member) having a drum shape (cylindrical shape), as a first image bearing member is rotationally driven in a direction of an arrow R1 (counterclockwise direction) in FIG. 1. A surface of the rotating photosensitive drum 11 is uniformly charged, by the charging roller 12, which is a charging member (charger) having a roller shape, as a charging means, to a predetermined potential of predetermined polarity (negative polarity in the present Embodiment).

The charged surface of the photosensitive drum 11 is scanned and exposed in accordance with the image signal by the exposure device 13, and an electrostatic latent image (electrostatic image) is formed on the photosensitive drum 11. The image signal is converted into a laser beam, which is subjected to pulse width modulation (PWM), control by the control portion 5. The exposure device 13 is configured to include a polygon scanner, scans the laser beam in accordance with the image signal, and irradiates the photosensitive drum 11 of each image forming unit 10 with the laser beam. The electrostatic latent image formed on the photosensitive drum 4 is developed (visualized) by toner as developer being supplied by the developing device 14 as a developing means, and a toner image (developer image) is formed on the photosensitive drum 11. In the present Embodiment, to an exposed portion on the photosensitive drum 11, in which an absolute value of the potential is decreased by being exposed after having been uniformly charged, the developing device 14 causes the toner charged to the same polarity as the charging polarity of the photosensitive drum 11 (negative polarity in the present Embodiment) to be adhered. In the present Embodiment, normal charging polarity of the toner, which is main charging polarity of the toner during development, is negative polarity.

So as to be opposite to the four photosensitive drums 11, an intermediary transfer unit 20 is disposed. The intermediary transfer unit 20 includes, as a second image bearing member, an intermediary transfer belt 21 which is an intermediary transfer member constituted by an endless belt. The intermediary transfer belt 21 is stretched around a driving roller 22, a tension roller 23, and a secondary transfer opposite roller 24 as a plurality of stretching rollers, and is stretched at predetermined tensile force. The intermediary transfer belt 21 is rotated (circulated), by the driving roller 22 being rotationally driven, in a direction of an arrow R2 (clockwise direction) in FIG. 1. On an inner peripheral surface side of the intermediary transfer belt 21, corresponding to the respective photosensitive drums 11Y, 11M, 11C, and 11K, primary transfer rollers 25Y, 25M, 25C, and 25K, which are primary transfer members having roller shapes as primary transfer means, are disposed. The primary transfer roller 25 is pressed toward the photosensitive drum 11 via the intermediary transfer belt 21, and forms a primary transfer portion (primary transfer nip portion) T1, which is a contacting portion between the photosensitive drum 11 and the intermediary transfer belt 21. The stretching rollers other than the driving roller 22 and each primary transfer roller 25 are rotated driven by the rotation of the intermediary transfer belt 21. The toner image formed on the photosensitive drum 11 is transferred (primarily transferred), in the primary transfer portion T1, onto the rotating intermediary transfer belt 21. During primary transfer, to the primary transfer roller 25, a primary transfer bias (primary transfer voltage) having opposite polarity to the normal charging polarity of the toner (positive polarity in the present Embodiment) is applied. As a result, the primary transfer roller 25 performs electric discharge from the inner peripheral surface of the intermediary transfer belt 21, and causes the toner image on the photosensitive drum 11 to be transferred onto the intermediary transfer belt 21. For example, during formation of a full-color image, toner images of respective colors of yellow, magenta, cyan, and black formed on the respective photosensitive drums 11Y, 11M, 11C, and 11K are sequentially transferred so as to be superimposed on the same image forming area on the intermediary transfer belt 21. The surface of the photosensitive drum 11 after the primary transfer is cleaned by the drum cleaning device 15 as a photosensitive member cleaning means.

On an outer peripheral surface side of the intermediary transfer belt 21, at a position opposite to the secondary transfer opposite roller 24 via the intermediary transfer belt 21, a secondary transfer roller 8, which is a secondary transfer member having a roller shape, as a secondary transfer means is disposed. The secondary transfer roller 8 is pressed toward the secondary transfer opposite roller 24 via the intermediary transfer belt 21, and forms a secondary transfer portion (secondary transfer nip portion) T2, which is a contacting portion between the intermediary transfer belt 21 and the secondary transfer roller 8. The toner image formed on the intermediary transfer belt 21 is transferred (secondarily transferred), in the secondary transfer portion T2, onto the recording material P which is being nipped and conveyed by the intermediary transfer belt 21 and the secondary transfer roller 8. During secondary transfer, to the secondary transfer roller 8, a secondary transfer bias (secondary transfer voltage) having opposite polarity to the normal charging polarity of the toner (positive polarity in the present Embodiment) is applied. As a result, the secondary transfer roller 8 forms a secondary transfer electric field in the secondary transfer portion T2, and causes the toner image on the intermediary transfer belt 21 to be transferred onto the recording material P. The surface of the intermediary transfer belt 21 after the secondary transfer is cleaned by a belt cleaning device 26 as an intermediary transfer member cleaning means. In the present Embodiment, the intermediary transfer unit 20 is configured to include the intermediary transfer belt 21, the stretching rollers 22, 23, and 24, each primary transfer roller 25, the belt cleaning device 26, etc.

The recording material P is fed from a feeding portion 6 as a feeding means, and is conveyed toward the secondary transfer portion T2. The feeding portion 6 is configured to include a cassette 61 as an accommodating portion, a feeding roller 62 as a feeding member, a conveyance roller 63 as a conveyance member, etc. The recording material P accommodated in the cassette 61 is separated one by one by the feeding roller 62, etc., and sent out from the cassette 61. This recording material P is conveyed, by the conveyance roller 63, to a registration roller pair (registration portion) 7 as a synchronizing conveyance member. The recording material P is conveyed, after being made to wait by the registration roller pair 7, with a timing being controlled in order to align positions between the toner image on the intermediary transfer belt 21 and the recording material P, to the secondary transfer portion T2 by the registration roller pair 7.

The recording material P, onto which the toner image has been transferred, is conveyed to a fixing device 30 which is an image heating device as a fixing means. The fixing device 30 heats and presses the recording material P bearing the unfixed toner image, and fixes (melts, sticks) the toner image onto the recording material P (fixing operation, fixing process). In a case of single-sided printing, the recording material P, to which the toner image has been fixed by passing through the fixing device 30, is thereafter discharged (output) to an outside of the image forming apparatus 1 (outside the machine), and is stacked on a discharge tray 9 as a discharging portion. In a case of double-sided printing, when the transfer and the fixing of the toner image to a first side (first side for image formation) of the recording material P are completed, the recording material P is conveyed to a reversing portion 64 provided inside the printer portion 3. And, the transfer and the fixing of the toner image to a second side (second side for image formation) of the recording material P, of which front and back sides have been reversed in the reversing portion 64, are performed. This recording material P is thereafter discharged outside the machine, and is stacked on the discharge tray 9.

In the present Embodiment, the image forming portion 100, which forms the toner image on the recording material P, is constituted by each image forming unit 10, the intermediary transfer unit 20, the secondary transfer roller 8, etc.

### <Configuration of the Fixing Device>

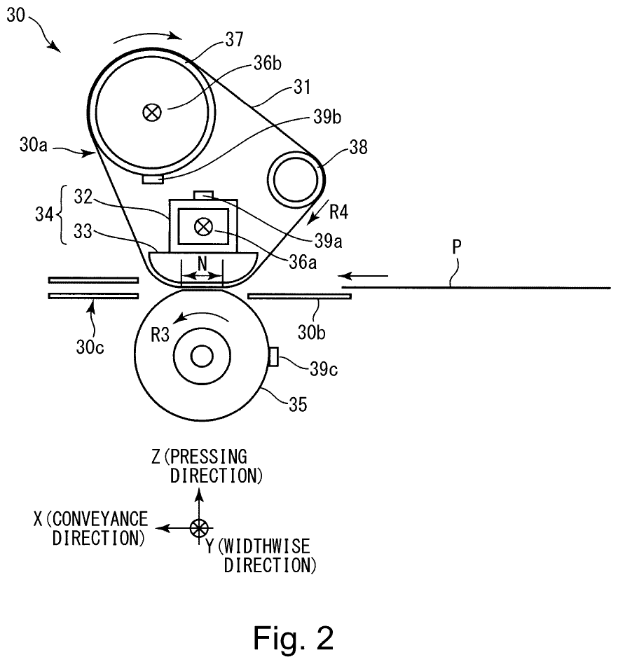

Next, a configuration of the fixing device 30 in the present Embodiment will be described. In the present Embodiment, the fixing device 30 is a fixing device of belt heating type. FIG. 2 is a cross-sectional view illustrating an outline configuration of the fixing device 30 in the present Embodiment (illustrating a cross section approximately perpendicular to a rotational axis direction of a heating roller 37, which will be described below).

In FIG. 2, an X direction indicates a conveyance direction of the recording material P, a Y direction indicates a width direction perpendicular to the conveyance direction of the recording material P, and a Z direction indicates a direction perpendicular to both the X direction and the Y direction. The Y direction (width direction of the recording material P) is approximately parallel to the rotational axis direction (a longitudinal direction) of the heating roller 37 and that of a pressing roller 35, which will be described below. In addition, the Z direction is approximately parallel to a direction (pressing direction), in which the recording material P is pressed by the pressing roller 35 against a pressing pad 33 via a fixing belt 31 as will be described below. In the present Embodiment, the fixing device 30 is disposed so that the Y direction becomes approximately parallel to the front-rear direction connecting the front side and the rear side of the image forming apparatus 1. In addition, in the present Embodiment, the fixing device 30 is disposed so that the Z direction becomes approximately parallel to a direction of gravity.

The fixing device 30 includes, as a fixing member, the fixing belt 31 which is a rotatable heating member constituted by a rotatable endless belt. In addition, the fixing device 30 includes the pressing pad (fixing pad) 33 as a nip forming member, which forms a fixing nip portion N together with the pressing roller 35, and a stay 32 as a supporting member for supporting the pressing pad 33. The stay 32 and the pressing pad 33 constitute a pad portion 34 as a first heating member. In addition, the fixing device 30 includes the heating roller 37 as a second heating member serving also as a stretching roller, and a steering roller 38 as a stretching roller. In addition, the fixing device 30 includes the pressing roller 35 as a pressing member (rotatable pressing member) disposed opposite to the fixing belt 31. In addition, the fixing device 30 includes a heater inside the stay (first heater) 36a as a first heating source, and a heater inside the heating roller (second heater) 36b as a second heating source. The fixing belt 31, the pad portion 34 (the stay 32, the pressing pad 33), the heating roller 37, the heater inside the stay 36a, the heater inside the heating roller 36b, and the steering roller 38 constitute a heating unit 30a which applies heat to the toner image on the recording material P. In addition, the fixing device 30 includes a first, a second, and a third temperature detecting element 39a, 39b, and 39c as temperature detecting means. Further, the fixing device 30 includes an inlet guide 30b, which guides the recording material P toward the fixing nip portion N, a separating guide 30c for separating the recording material P, which has passed through the fixing nip portion N, from the fixing belt 31, etc.

The fixing belt 31 is a member having a thin cylindrical shape with thermal conductivity and heat resistance. In the present Embodiment, the fixing belt 31 has a three-layer structure including a base layer, an elastic layer formed on an outer periphery of the base layer, and a releasing layer formed on an outer periphery of the elastic layer. In the present Embodiment, the base layer has a thickness of 80 μm, and a polyimide resin (PI) is used as material thereof. In addition, in the present Embodiment, the elastic layer has a thickness of 300 μm, and silicone rubber is used as material thereof. In addition, in the present Embodiment, the releasing layer has a thickness of 30 μm, and PFA (tetrafluoroethylene perfluoroalkoxyethylene copolymerization resin), which is fluororesin, is used as material thereof. The fixing belt 31 is stretched by the pressing pad 33, the heating roller 37, and the steering roller 38.

The pressing pad 33 is pressed against the pressing roller 35 across the fixing belt 31. The pressing pad 33 is supported by the stay 32. In the present Embodiment, as material of the pressing pad 33, LCP (liquid crystal polymer), which is material having heat resistance, is used. In addition, in the present Embodiment, between the pressing pad 33 and the fixing belt 31, a sliding member (not shown) is interposed. The sliding member is constituted by, for example, a releasing layer having releasing property, etc. In addition, in the present Embodiment, to an inner peripheral surface of the fixing belt 31, a lubricant is applied. By this, the fixing belt 31 slides smoothly with respect to the sliding member. In the present Embodiment, as the lubricant, silicone oil is used. Incidentally, the sliding member may be omitted.

The stay 32 is a member which supports the pressing pad 33 and heats the fixing belt 31 via the pressing pad 33, and is constituted by a hollow pipe (tubular member). In the present Embodiment, the stay 32 is constituted by a square pipe made of SUS (stainless steel) having a thickness of 3 mm. In the present Embodiment, the stay 32 is configured to be made of stainless steel, however, it is not limited to stainless steel as long as metal ensures rigidity. The stay 32 is supported by a frame (not shown) of the fixing device 30, etc. The stay 32 and the pressing pad 33 are contacting each other. Inside (in a hollow portion of) the stay 32, the heater inside the stay 36a constituted by a halogen heater as a heat source is disposed. The stay 32 is capable of generating heat up to a predetermined temperature. The fixing belt 31 is heated by the stay 32 via the pressing pad 33. Incidentally, in FIG. 2, one heater inside the stay 36a is shown, however, the heater inside the stay 36a may be two or more.

The heating roller 37 is a member which heats the fixing belt 31, and is constituted by a hollow pipe (tubular member). In the present Embodiment, the heating roller 37 is constituted by a pipe (circular pipe) made of aluminum material (aluminum or aluminum alloy) having a thickness of 2 mm. The heating roller 37 is rotatably supported by the frame (not shown) of the fixing device 30, etc. The rotational axis direction of the heating roller 37 is approximately parallel to the rotational axis direction of the photosensitive drum 11. Inside (in a hollow portion of) the heating roller 37, the heater inside the heating roller 36b constituted by a halogen heater as a heat source is disposed. The heating roller 37 is capable of generating heat up to a predetermined temperature. The fixing belt 31 is heated by the heating roller 37. Incidentally, in FIG. 2, one heater inside the heating roller 36b is shown, however, the heater inside the heating roller 36b may be two or more.

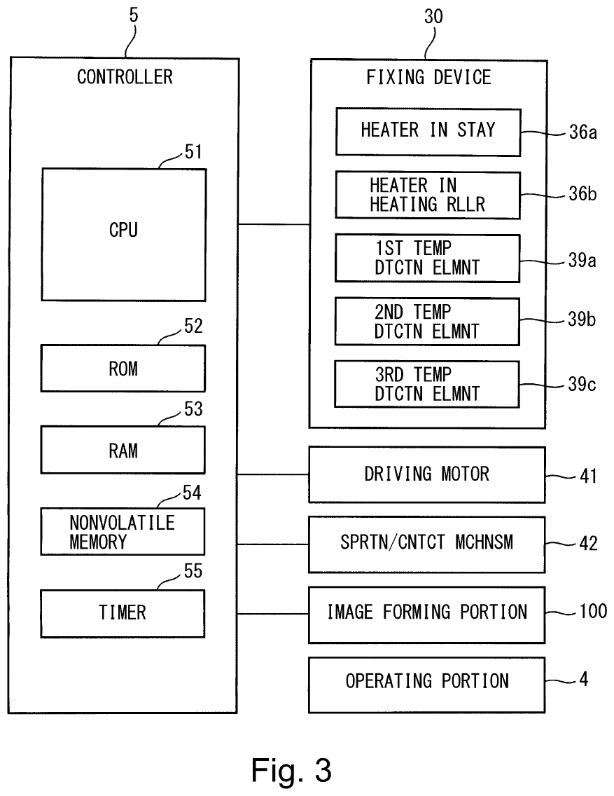

The pressing roller 35 is a roller including a core metal layer (rotation shaft), an elastic layer formed on an outer periphery of the core metal layer, and a releasing layer formed on an outer periphery of the elastic layer. In the present Embodiment, the core metal layer is formed of a tubular member made of SUS (stainless steel) having a diameter of 44 mm. In addition, in the present Embodiment, the elastic layer has a thickness of 8 mm, and electroconductive silicone rubber is used as material thereof. In addition, in the present Embodiment, the releasing layer has a thickness of 100 μm, and PFA (tetrafluoroethylene perfluoroalkoxyethylene copolymerization resin), which is fluororesin, is used as material thereof. The pressing roller 35 is rotatably and pivotally supported by a pressing arm (not shown) as a moving member movably provided to the frame (not shown) of the fixing device 30, etc. The rotational axis direction of the pressing roller 35 is approximately parallel to the rotational axis direction of the photosensitive drum 11 and the rotational axis direction of the heating roller 37. In the pressing roller 35, a gear is fixed to one end portion in the rotational axis direction thereof, and the pressing roller 35 is connected to a driving motor 41 (FIG. 3) as a driving source via the gear. And the pressing roller 35 is rotationally driven, by driving force transmitted from the driving motor 41, in a direction of an arrow R3 (counterclockwise direction) in FIG. 2. The pressing roller 35 forms, by contacting the pressing pad 33 via the fixing belt 31, the fixing nip portion (fixing portion) N together with the fixing belt 31. The fixing belt 31 is rotated (circulated), by being nipped between the pressing roller 35 and the pressing pad 33, in a direction of an arrow R4 (clockwise direction) in FIG. 2, driven by the rotation of the pressing roller 35. In addition, the pressing arm described above constitutes a contacting and separating mechanism 42 (FIG. 2) as a contacting and separating means. The pressing arm described above is configured to be movable so as to cause the pressing roller 35 to be contacted to or be separated from the fixing belt 31 (be in contact with or separated from the pressing pad 33).

The first, the second, and the third temperature detecting elements 39a, 39b, and 39c are disposed so as to contact members to be detected, respectively. Specifically, the first temperature detecting element (stay temperature sensor) 39a is disposed so as to contact a surface (outside surface) of the stay 32, and is used to detect a surface temperature of the stay 32. In addition, the second temperature detecting element (heating roller temperature sensor) 39b is disposed so as to contact a surface (outer peripheral surface) of the heating roller 37, and is used to detect a surface temperature of the heating roller 37. In addition, the third temperature detecting element (pressing roller temperature sensor) 39c is disposed so as to contact a surface (outer peripheral surface) of the pressing roller 35, and is used to detect a surface temperature of the pressing roller 35. The first, the second, and the third temperature detecting elements 39a, 39b, and 39c output signals (for example, voltage signals) corresponding to temperatures of the members to be detected to the control portion 5, respectively. The first, the second, and the third temperature detecting elements 39a, 39b, and 39c are configured to include, for example, a thermistor, a thermocouple, etc., respectively. Incidentally, at least one of the first, the second, and the third temperature detecting elements 39a, 39b, and 39c may be constituted by a plurality of temperature detecting elements disposed at a plurality of positions in the width direction approximately perpendicular to a moving direction of the surface of the fixing belt 31. In addition, the temperature detecting means may be a temperature detecting means which detects a temperature without contacting a member to be detected.

The fixing device 30 heats, in the fixing nip portion N formed between the fixing belt 31 and the pressing roller 35, the toner image on the recording material P while nipping and conveying the recording material P bearing the toner image. In this manner, the fixing device 30 fixes, while nipping and conveying the recording material P, the toner image onto the recording material P. Therefore, for the fixing device 30, it is necessary to serve both of a function for applying the heat and the pressure and a function for conveying the recording material P. By the pressing roller 35 being rotationally driven by the driving motor 41 as the driving source, the fixing belt 31 is rotated driven by the rotation of the pressing roller 35. The pressing roller 35 is pressed against the pressing pad 33 via the fixing belt 31. In the present Embodiment, pressing force in the fixing nip portion N during fixing operation is set to 1600 N. In addition, in the present Embodiment, a width of the fixing nip portion N in the X direction (conveyance direction of the recording material P) during fixing operation is set to 20 mm, and a width of the fixing nip portion N in the Y direction (width direction of the recording material P) during fixing operation is set to 350 mm.

The steering roller 38 is rotated (tilted), about a rotational axis positioned at one end portion side or in a vicinity of a center in the rotational axis direction thereof, so that a rotational axis direction of the steering roller 38 is inclined with respect to the rotational axis direction of the heating roller 37. By this, the steering roller 38 generates a difference in tension between the front side and the rear side of the fixing belt 31, and controls a position of the fixing belt 31 in the Y direction (width direction of the recording material P). In the present Embodiment, the steering roller 38 is constituted by a hollow roller (shaft) made of SUS (stainless steel) having a diameter of 20 mm. Incidentally, in order to increase a gripping force against the fixing belt 31, a surface layer constituted by rubber material, etc. may be provided on a surface of the steering roller 38.

### <Control Configuration of the Image Forming Apparatus>

Next, a control configuration of the image forming apparatus 1 in the present Embodiment will be described. FIG. 3 is a block diagram illustrating an outline control configuration of the image forming apparatus 1 in the present Embodiment.

The image forming apparatus 1 includes the control portion 5 as a control means which comprehensively controls the image forming apparatus 1. The control portion 5 is configured to include a CPU 51 as an arithmetic process means (arithmetic process portion), a ROM 52, a RAM 53, and a non-volatile memory 54 as storage means (storage portions), a timer 55 as a time measuring means (time measuring portion), and an input/output circuit (not shown) as an input/output means (input/output portion). The CPU 51 performs the control of the image forming apparatus 1. In the ROM 52, a control program, an application program, etc., which are executed by the CPU 51, are stored. The RAM 53 functions as a working area for executing a process of the control program. The non-volatile memory 54 holds data such as various types of settings which are desired to be held even when power of the image forming apparatus 1 is turned off. The timer 55 is capable of generation of a periodic time interval for the control and measurement of an elapsed time between two points.

To the control portion 5, an operating portion (UI) 4, which is provided to the image forming apparatus 1, is connected. The operating portion 4 is configured to include a display portion, which performs display of information to a user (an operator) through control by the control portion 5, and an input portion, which inputs information such as various types of settings to the control portion 5 based on an operation from the user. The operating portion 4 may be configured to include a touch panel, etc. having the function of the display portion and the function of the input portion. In this case, the operating portion 4 performs screen display to the user and reception of a touch input from the user.

In addition, to the control portion 5, various types of loads, sensors, etc. constituting the fixing device 30 are connected. In the present Embodiment, to the control portion 5, the heater inside the stay 36a (a power supplying portion to the heater inside the stay 36a), the heater inside the heating roller 36b (a power supplying portion to the heater inside the heating roller 36b), and the first, the second, and the third temperature detecting elements 39a, 39b, and 39c are connected. Operations of the respective heaters 36a and 36b and the respective temperature detecting elements 39a, 39b, and 39c are controlled based on control signals from the control portion 5, respectively. In addition, to the control portion 5, the driving motor 41 and the contacting and separating mechanism 42 are connected. Operations of the driving motor 41 and the contacting and separating mechanism 42 are controlled based on control signals from the control portion 5, respectively.

Based on the received print information, by controlling an operation of each portion of the image forming apparatus 1 such as the image forming portion 100, the fixing device 30, the driving motor 41, and the contacting and separating mechanism 4, the control portion 5 controls the image forming apparatus 1 so as to execute a job. The print information includes a start instruction for a print, various types of settings on the print (for example, a type of the recording material P, a number of copies to be printed), etc. The job is a series of operations which is started by one start instruction and in which an image is formed and output on a single or a plurality of the recording material P. The user may input the information on the various types of settings such as the type of the recording material P used in the job and the number of copies to be printed to the control portion 5 from the operating portion 4 (or the external host device). And the control portion 5 executes, based on the various types of settings input by the user, an operation for the job including the image formation based on the image signal and the fixing operation in the fixing device 30, etc.

Incidentally, the control portion 5, which controls each portion of the fixing device 30, may also be regarded as a portion constituting the fixing device 30.

### <Temperature Rising Speeds of the Heating Members and the Fixing Member>

First, temperature rising speeds of the heating members will be described. The pad portion 34 and the heating roller 37 constitute the heating members for heating the fixing belt 31, respectively. In other words, the stay 32 is the supporting member, which supports the pressing pad 33, and is the heating member which heats the fixing belt 31 via the pressing pad 33. Here, heating of the fixing belt 31 by the pad portion 34 may be described as heating of the fixing belt 31 by the stay 32. Inside the stay 32 and the heating roller 37, the heater inside the stay 36a and the heater inside the heating roller 36b as heating sources are disposed, respectively. The temperature rising speed of the heating member is determined by, for example, a heat capacity of a member being used and an amount of heat applied from a heating source. Specifically, the larger the heat capacity of the heating member is, the slower the temperature rising speed becomes, and the larger a heating amount of the heating source is, the faster the temperature rising speed becomes.

Next, the temperature rising speed of the fixing member will be described. The temperature rising speed of the fixing belt 31 as the fixing member is determined by, for example, the temperature rising speed of the heating member, thermal physical properties including a thermal conductivity of the heating member, etc., and a contact state between the fixing belt 31 and the heating member. Specifically, the temperature rising speed of the fixing belt 31 by the stay 32 is determined by a heat capacity of the stay 32, a heating amount of the heater inside the stay 36a, a thermal physical property and a thermal conduction characteristic of the pressing pad 33 disposed between the fixing belt 31 and the stay 32, a thermal physical property of the sliding member disposed between the pressing pad 33 and the fixing belt 31, and thermal resistances and contact areas between the respective members of the fixing belt 31, the sliding member, the pressing pad 33, and the stay 32. In addition, the temperature rising speed of the fixing belt 31 by the heating roller 37 is determined by a heat capacity of the heating roller 37, a heating amount of the heater inside the heating roller 36b, and a thermal resistance and a contact area between the fixing belt 31 and the heating roller 37.

In the present Embodiment, the stay 32 and the heating roller 37 are designed so as to have heat capacities shown in Table 1, respectively. In other words, in the present Embodiment, the heat capacity of the stay 32 is larger than the heat capacity of the heating roller 37. Therefore, in the present Embodiment, the heat capacity of the pad portion 34 is larger than the heat capacity of the heating roller 37. In addition, in the present Embodiment, the heater inside the stay 36a is designed so as the heating amount (a maximum heating amount) thereof to be 300 W, and the heater inside the heating roller 36b is designed so as the heating amount (a maximum heating amount) thereof to be 1400 W. In other words, in the present Embodiment, the heating amount (maximum heating amount) of the heater inside the heating roller 36b is larger than the heating amount (maximum heating amount) of the heater inside the stay 36a. Therefore, the temperature rising speed of the heating roller 37 is faster than the temperature rising speed of the stay 32.

In addition, the heating roller 37 contacts the fixing belt 31 in a range of 60 mm in a peripheral direction of the heating roller 37. In addition, the stay 32 contacts, via the pressing pad 33, the fixing belt 31 in a range of 20 mm in the conveyance direction of the recording material P. Further, the pressing pad 33 is constituted by using LCP, as the material thereof, having a thickness of about 3 mm and a thermal conductivity of about 0.38 W/m K. Therefore, the temperature rising speed of the fixing belt 31 by the heating roller 37 in a case in which the heater inside the heating roller 36b generates the heat with the maximum heating amount is faster than the temperature rising speed of the fixing belt 31 by the stay 32 in a case in which the heater inside the stay 36a generates the heat with the maximum heating amount. This is because by the pressing pad 33 having a thermal conductivity smaller than that of the stay 32 being sandwiched as a heat insulating member between the fixing belt 31 and the stay 32, it is suppressed that heat of the fixing belt 31 is taken by the stay 32, which has the large heat capacity, at the fixing nip portion N. In the present Embodiment, in the case in which the heater inside the heating roller 36b generates the heat with the maximum heating amount, the temperature rising speed of the fixing belt 31 by the heating roller 37 is approximately 2 °C/s. In addition, in the present Embodiment, in the case in which the heater inside the stay 36a generates the heat with the maximum heating amount, the temperature rising speed of the fixing belt 31 by the stay 32 (in other words, the pad portion 34) is approximately 0.05 °C/s. In other words, in the present Embodiment, the temperature rising speed of the fixing belt 31 by the heating roller 37 in the case in which the heater inside the heating roller 36b generates the heat with the maximum heating amount is faster than the temperature rising speed of the fixing belt 31 by the stay 32 (in other words, the pad portion 34) in the case in which the heater inside the stay 36a generates the heat with the maximum heating amount.

TABLE 1

| | | Specific | | | Heat |
|---|---|---|---|---|---|
| MEMBER | MATERIAL | heat | Density | Volume | capacity |
| NAME | NAME | [J/g K] | [g/cm³] | [mm³] | [J/K] |
| HEATING | Aluminum | 0.94 | 2.7 | 130000 | 330 |
| ROLLER | | | | | |
| STAY | Stainless | 0.5 | 7.93 | 109000 | 432 |

Here, from a viewpoint of control, an outline of a role of each heating member will be described. The heating roller 37 has, as a main heating member for heating the fixing belt 31, a role of adjusting a temperature of the fixing belt 31 sequentially. On the other hand, the stay 32 has, as an auxiliary heating member for heating the fixing belt 31, in a case in which it is necessary, a role of assisting to keep the temperature of the fixing belt 31 by raising temperatures of the members inside the fixing belt 31 (inside an area surrounded by an inner peripheral surface of the fixing belt 31) entirely. The case in which it is necessary is, for example, during continuous printing using the recording material P (thick paper, etc.), to which it is required to apply a relatively large amount of the heat, etc., a case in which temperature rising performance of the fixing belt 31 is insufficient only with the heating roller 37. Therefore, during continuous printing using the recording material P (plain paper, thin paper, etc.), to which it is not required to apply the relatively large amount of the heat, or in a case in which a number of prints is small, etc., there is a case in which it is sufficient only with the temperature rising ability of the fixing belt 31 by the heating roller 37, and the auxiliary temperature rising ability of the fixing belt 31 by the stay 32 is not necessary.

### <Classification of States of the Fixing Device>

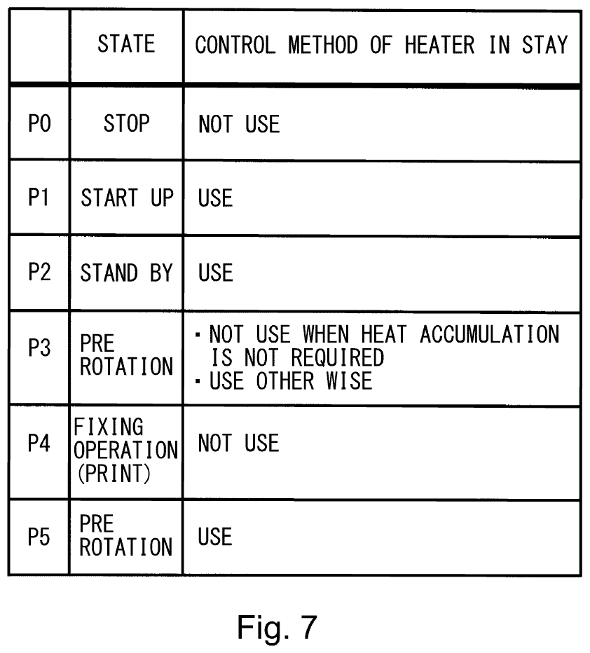

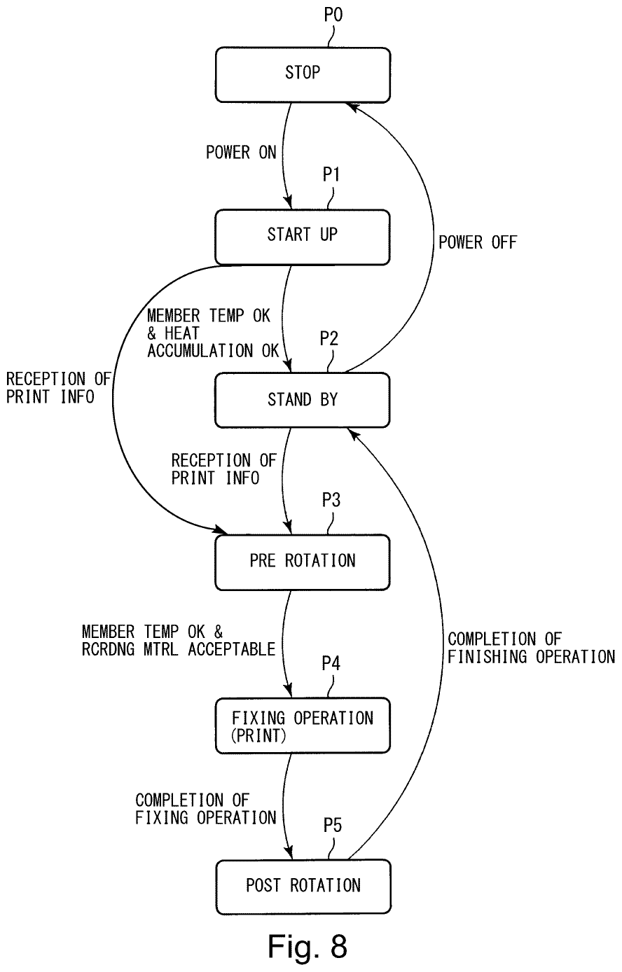

States of the fixing device 30 in the present Embodiment will be described. As shown in FIG. 7, the states of the fixing device 30 in the present Embodiment may be classified, when roughly divided, into six states of a stop P0, a start up P1, a standby P2, a pre rotation P3, a fixing operation P4, and a post rotation P5. FIG. 8 is a schematic view illustrating a flow of how each state shown in FIG. 7 transitions.

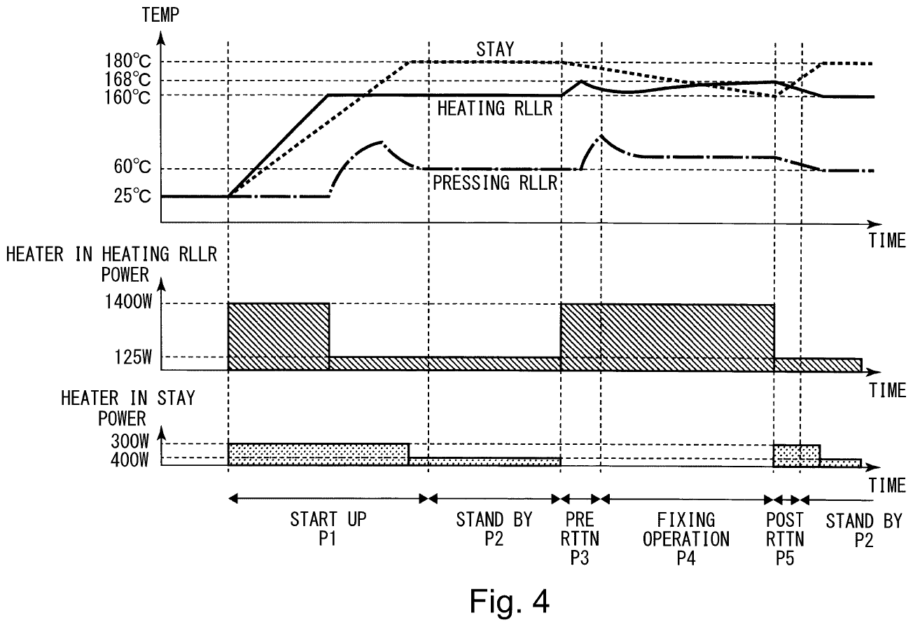

FIG. 4 is a graph view showing, in a representative transition of the states of the fixing device 30 in the present Embodiment, transition of the temperature of each member, transition of power consumption of the heater inside the heating roller 36b, and transition of power consumption of the heater inside the stay 36a. In this example, a target temperature of the heating roller 37 is 160 °C during the start up P1, during the standby P2, and during the post rotation P5, and is 168 °C during the pre rotation P3 and during the fixing operation P4. The control portion 5 performs control, so that the temperature of the heating roller 37 becomes the target temperature, of power supply (ON/OFF control, etc.) to the heater inside the heating roller 36b. In addition, in this example, a target temperature of the stay 32 is 180 °C. The control portion 5 performs control, so that the temperature of the stay 32 becomes the target temperature, of power supply (ON/OFF control, etc.) to the heater inside the stay 36a. In the present Embodiment, the target temperature of the stay 32 during the start up P1 is higher than the target temperature of the heating roller 37 during the start up P1 (and during the fixing operation P4). In addition, a dedicated heating source is not provided for the pressing roller 35, however, by bringing the pressing roller 35 into contact with the fixing belt 31 during the start up P1, the pressing roller 35 is caused to accumulate the heat so that the temperature of the pressing roller 35 becomes about 60 °C. Incidentally, in the present Embodiment, the pressing roller 35 is brought into contact with the fixing belt 31 during the start up P1 temporarily. In addition, in the present Embodiment, the pressing roller 35 is separated from the fixing belt 31 during the stop P0 and during the standby P2. And the pressing roller 35 is brought into contact with the fixing belt 31 during the pre rotation P3, is kept in contact with the fixing belt 31 in the fixing operation P4, and is separated from the fixing belt 31 during the post rotation P5.

With reference to FIG. 8, each state will be briefly described. Here, an outline of each state will be described, and details of a control method for the heater inside the stay 36a, which is characteristic in the present Embodiment, will be described below.

The stop P0 is a state, such as a situation in which the power of the image forming apparatus 1 is turned off, in which the fixing device 30 is completely stopped (rotational drive and energization to the heating sources are stopped). Incidentally, the stop P0 includes, in addition to a state in which energization to all elements of the image forming apparatus 1 is stopped, a state in which energization to some elements such as the control portion 5 is possible but the fixing device 30 is completely stopped (a sleep state of the image forming apparatus 1).

The start up P1 is a state from a timing when the power of the image forming apparatus 1 is turned on (ON) (or the sleep state of the image forming apparatus 1 is released), until the temperature of each member of the fixing device 30 such as the heating roller 37 toward the target temperature thereof is adjusted, through the heat accumulation process, and the fixing device 30 transitions to the standby P2. In addition, the start up P1 is a state, in a case in which the control portion 5 receives the print information during the start up P1, until the fixing device 30 transitions to the pre rotation P3 without going through the standby P2.

The standby P2 is a state in which the fixing device 30 may transition to the pre rotation P3, which is preparation for the fixing operation (preparation for printing) at any time upon the temperature of each member of the fixing device 30 such as the heating roller 37 reaching the target temperature and the print information being input to the control portion 5.

The pre rotation P3 is a state, from the standby P2 (or the start up P1) until the print information is input to the control portion 5 and the fixing device 30 prepares for receiving the recording material P for the fixing operation P4. More specifically, in the present Embodiment, in the pre rotation P3, an operation for changing the target temperature of the heating roller 37, an operation for changing a process speed, and an operation for bringing the pressing roller 35 into contact with the fixing belt 31 are performed. In the present Embodiment, the target temperatures (fixing temperatures, adjusting temperatures) of the heating roller 37 are set in advance corresponding to the types of the recording material P (paper types), and are stored in the ROM 52. In addition, in the present Embodiment, the process speeds are set in advance corresponding to the types of the recording material P (paper types), and are stored in the ROM 52. The process speed is equivalent to a peripheral speed (moving speed of the surface) of the fixing belt 31. The control portion 5 sets, for each job, based on the information on the type of the recording material P included in the acquired print information, the target temperature of the heating roller 37 and the process speed to the fixing device 30.

The fixing operation P4 is a state in which the fixing device 30 is receiving the recording material P, applying the heat and the pressure to the toner image on the recording material P, and fixing the toner image onto the recording material P. Here, the fixing operation P4 includes states of the fixing device 30 in a standby period which may occur due to preparation in the image forming portion 100, etc. despite the fixing device 30 is ready to receive the recording material P, and in a period between a preceding recording material P and a succeeding recording material P (sheet interval) which occurs upon conveying a plurality of the recording material P. Since the fixing operation P4 may be regarded as a printing operation in the fixing device 30, the “fixing operation P4” may also be referred to as a “printing P4”.

The post rotation P5 is a state in which after the fixing operation P4 is completed and all the recording materials P in the job have passed through the fixing device 30, preparation for causing the fixing device 30 to return to the standby P2 again is performed. More specifically, in the present Embodiment, in the post rotation P5, in order to cause the fixing device 30 to return to the standby P2, an operation for setting the target temperature of the heating roller 37 and the process speed back to initial values (default values), and an operation for separating the pressing roller 35 from the fixing belt 31 are performed.

In addition, from the standby P2, when the power of the image forming apparatus 1 is turned off, the fixing device 30 transitions to the stop P0. Alternatively, it may be configured that, in the standby P2, if a predetermined condition such as a predetermined time elapses is satisfied, the fixing device 30 transitions to the stop P0.

Incidentally, in the present Embodiment, the rotation of the pressing roller 35 is started at a time of start of the start up P1, the rotation of the pressing roller 35 is continued in the standby P2, the pre rotation P3, and the fixing operation P4, and the rotation of the pressing roller 35 is stopped in the post rotation P5. However, for example, the rotation of the pressing roller 35 may be stopped in at least a part of the periods in the start up P1 and the standby P2, respectively.

### <Control Method for the Heater Inside the Stay>

Next, a control method for the heater inside the stay 36a (temperature of the stay 32) in the present Embodiment will be described.

In the present Embodiment, as described before, the heater inside the heating roller 36b is designed so as the heating amount (maximum heating amount) to be 1400 W, and the heater inside the stay 36a is designed so as the heating amount (maximum heating amount) to be 300 W. In this case, electric powers required for maintaining the respective temperatures of the heating roller 37 and the stay 32 at the target temperatures during the standby P2 were measured. As a result, it is found that, in order to maintain the temperature of the heating roller 37 at about 160 °C, it is necessary to cause the heater inside the heating roller 36b to generate heat at 125 W on average. In addition, it is found that, in order to maintain the temperature of the stay 32 at about 180 °C, it is necessary to cause the heater inside the stay 36a to generate heat at 40 W on average.

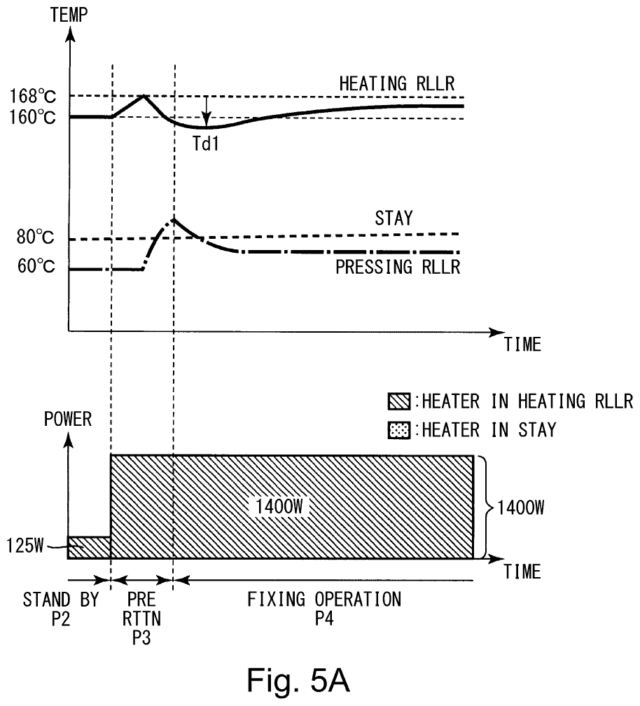

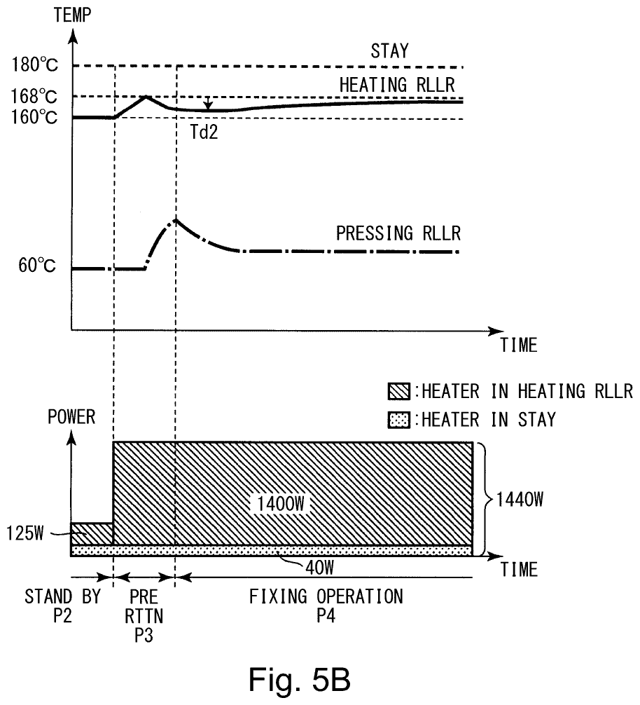

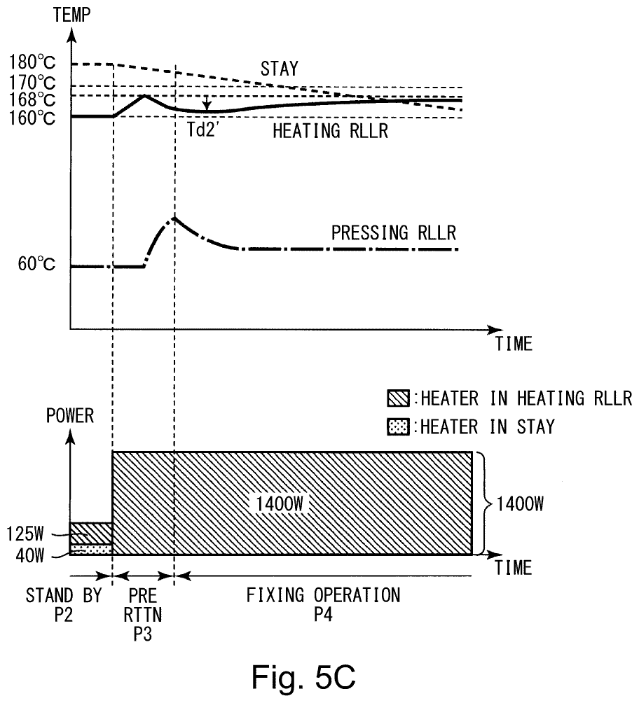

Based on this, power consumption during the fixing operation P4 was studied. FIGS. 5A, 5B, and 5C show study results of three conditions. FIG. 5A is a graph view showing, in a condition in which the heater inside the stay 36a is not used and the temperature of the stay 32 is lower than a target temperature (condition A), transition of the temperature of each member during the fixing operation P4 and electric power used by the respective heaters 36a and 36b. In addition, FIG. 5B is a graph view showing, in a condition in which the temperature of the stay 32 is constantly maintained at the target temperature by the heater inside the stay 36a (condition B), the transition of the temperature of each member during the fixing operation P4 and electric power used by the respective heaters 36a and 36b. In addition, FIG. 5C is a graph view showing, in a condition in which after maintaining the temperature of the stay 32 at the target temperature during the standby P2, the heater inside the stay 36a is not used in the pre rotation P3 and the fixing operation P4, and the temperature of the stay 32 gradually decreases (condition C), the transition of the temperature of each member during the fixing operation P4 and electric power used by the respective heaters 36a and 36b.

Here, a lowest temperature of the heating roller 37 upon the temperature of the heating roller 37 decreasing from a target temperature thereof as the fixing operation P4 is started is referred to as a “lowest point temperature”.

First, the transition of the temperature will be described. In the condition A (FIG. 5A), a lowest point temperature Td1 is 159 °C, which is lower than a target temperature of the heating roller 37 during the fixing operation P4, and falls below 161 °C, which is a temperature at which fixing performance can be ensured in the present Embodiment. Therefore, there is a possibility that the fixing performance decreases. In the condition B (FIG. 5B), a lowest point temperature Td2 is 162 °C, and since it is above 161 °C, which is the temperature at which the fixing performance can be ensured in the present Embodiment, it is possible to suppress the decrease in the fixing performance. In the condition C (FIG. 5C), a lowest point temperature Td2′ is 162 °C, which is the similar to the lowest point temperature Td2 in the case of the condition B.

From this study result, it is found that the lowest point temperature has high sensitivity to the temperature of the stay 32 at an initial stage of start of the fixing operation P4. In other words, it is found that while it is desired that the temperature of the stay 32 at the initial stage of start of the fixing operation P4 satisfies the target temperature, it is not necessary to maintain the temperature of the stay 32 at the target temperature during continuation of the fixing operation P4. This is considered to be due to the following reason. That is, in the present Embodiment, the target temperature of the stay 32 is set to 180 °C, and the target temperature of the heating roller 37 during the fixing operation P4 is set to 168 °C. And even if the heater inside the stay 36a is not used upon starting the fixing operation P4 and the temperature of the stay 32 starts to decrease, a decreasing speed of the temperature is approximately 0.1 °C/s. Therefore, at a timing when the temperature of the heating roller 37 becomes the lowest point temperature, the temperature of the stay 32 still exceeds the temperatures of the heating roller 37 and the fixing belt 31. As a result, it is possible to suppress transfer of the heat from the heating roller 37 and the fixing belt 31 to the stay 32. Therefore, for example, if the temperature of the stay 32 is constantly adjusted even during continuous printing, in other words, if supplying electric power to the heating source (heat generating element) is continued, electric power is used unnecessarily.

Here, the stay 32 may be regarded as a structural member having a large heat capacity or a slow temperature rising speed, which functions as the heating member which heats the fixing belt 31 via the pressing pad 33 and functions as the supporting member which supports the pressing pad 33. In the case in which the temperature of such a structural member is lower than the temperature of the fixing member, an amount of heat for heating the fixing member is also used for warming the structural member. Therefore, as in the present Embodiment, it may be considered to adopt a configuration in which this structural member is directly warmed by the heating source. In this case, it becomes possible to start the fixing operation in a state in which the structural member is sufficiently warmed, so that it becomes possible to suppress the decrease in the temperature of the fixing member and/or the heating member. However, as it may be seen from the study result described above, it is substantially only for a certain time after starting the fixing operation that the decrease in the temperature of the fixing member and/or the heating member due to the temperature of this structural member becomes a problem. Therefore, for example, if the temperature of the structural member is continuously adjusted even during continuous printing, in other words, if supplying electric power to the heating source (heat generating element) is continued, electric power is used unnecessarily.

Next, focusing on the power consumptions by the respective heaters 36a and 36b during the fixing operation P4 under the conditions in which the fixing performance is sufficient (the condition B and the condition C). In the condition B (FIG. 5B), electric power of 1440 W is consumed in total of the power consumption 1400 W of the heater inside the heating roller 36b and the power consumption 40 W of the heater inside the stay 36a. In the condition C (FIG. 5C), electric power of the power consumption 1400 W of the heater inside the heating roller 36b is consumed. In other words, in the condition C, it becomes possible to reduce the power consumption 40 W with respect to the condition (b) by not using the heater inside the stay 36a.

Incidentally, in the condition C, at a timing when the fixing operation P4 is completed, the temperature of the stay 32 falls below an aimed temperature (for example, 170 °C) as a temperature higher than the target temperature of the heating roller 37. However, even in a case in which the fixing operation P4 is continued in a state in which the heater inside the stay 36a is not used and the temperature of the stay 32 decreases in this manner, the temperature of the stay 32 finally converged to about 150 °C. And it is confirmed that by starting to warm the stay 32 by using the heater inside the stay 36a again from a timing at which the fixing operation P4 is completed and the fixing device 30 enters the post rotation P5, the temperature of the stay 32 can be returned to the target temperature sufficiently quickly.

Based on the study result described above, the control method for the heater inside the stay 36a in each state in the present Embodiment is summarized in FIG. 7.

In the start up P1, the standby P2, and the post rotation P5, by using the heater inside the stay 36a, the temperature of the stay 32 is maintained at the target temperature.

On the other hand, in the fixing operation P4, the heater inside the stay 36a is not used. As a result, it becomes possible to reduce the power consumption.

In addition, in the pre rotation P3, the heater inside the stay 36a may be used or may not be used. At a time of start of the pre rotation P3, since the control portion 5 has acquired the print information, it is possible to determine use/non-use of the heater inside the stay 36a in the pre rotation P3 based on that information. For example, in a case in which the recording material P is plain paper having a small basis weight, it is possible to obtain sufficient fixing performance even if the fixing operation P4 is started in the state in which the temperature of the stay 32 has fallen below the target temperature. Therefore, in this case, it may be configured not to use the heater inside the stay 36a in the pre rotation P3. On the other hand, for example, in a case in which the recording material P is plain paper having a large basis weight, coated paper, etc., in order to maintain the temperature of the stay 32 at a time of start of the fixing operation P4 at the target temperature and improve the fixing performance in the fixing operation P4, the heater inside the stay 36a may be used in the pre rotation P3. In the present Embodiment, in a case in which the recording material P is plain paper having a basis weight equal to or smaller than 90 gsm, it is known that it is possible to obtain sufficient fixing performance even if the fixing operation P4 is started in the state in which the temperature of the stay 32 has fallen below the target temperature. Therefore, in the present Embodiment, in the case in which the recording material P is plain paper and the basis weight thereof is equal to or smaller than 90 gsm, it is configured not to use the heater inside the stay 36a in the pre rotation P3 (a first mode). And, in the present Embodiment, in a case in which the recording material P is other than the plain paper having a basis weight equal to or smaller than 90 gsm, it is configured to use the heater inside the stay 36a in the pre rotation P3 (a second mode). Therefore, for example, in a case in which the recording material P is plain paper having a basis weight larger than 90 gsm, or in a case in which the recording material P is a recording material P having lower fixing performance than plain paper such as coated paper and thick paper, the heater inside the stay 36a is used in the pre rotation P3. Incidentally, it may be configured to determine the use/non-use of the heater inside the stay 36a in the pre rotation P3 depending on a basis weight set for each paper type category of the recording material P.

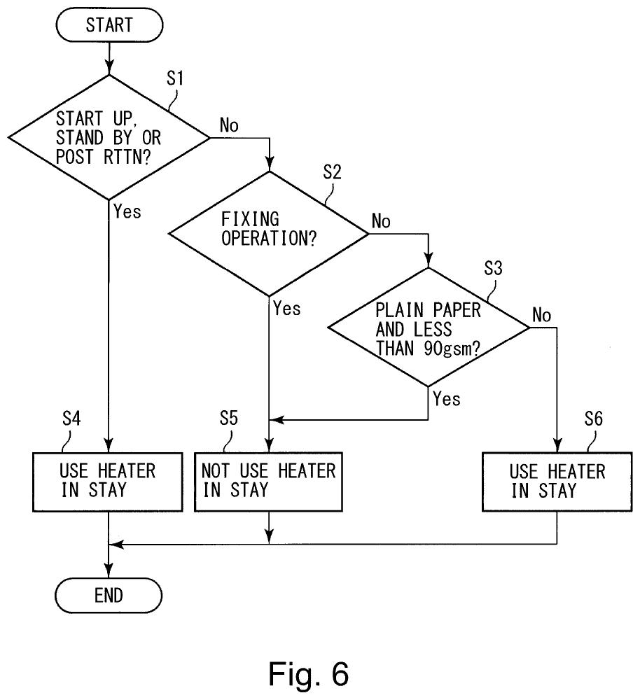

FIG. 6 is a flowchart diagram showing an example of a control procedure for the heater inside the stay 36a in the present Embodiment.

First, the control portion 5 determines whether or not the state of the fixing device 30 is the start up P1, the standby P2, or the post rotation P5 (S1). If the control portion 5 determines that the state of the fixing device 30 is the start up P1, the standby P2, or the post rotation P5 in S1, then the control portion 5 controls to use the heater inside the stay 36a (S4). If the control portion 5 determines that the state of the fixing device 30 is not the start up P1, the standby P2, or the post rotation P5 in S1, then the control portion 5 determines whether or not the state of the fixing device 30 is the fixing operation P4 (S2). If the control portion 5 determines that the state of the fixing device 30 is the fixing operation P4 in S2, then the control portion 5 controls not to use the heater inside the stay 36a (S5). If the control portion 5 determines that the state of the fixing device 30 is not the fixing operation P4 in S2, then the control portion 5 determines whether or not the type of the recording material P used for printing is plain paper and the basis weight is equal to or smaller than 90 gsm (S3). If the control portion 5 determines that the type of the recording material P is plain paper and the basis weight is equal to or smaller than 90 gsm in S3, then the control portion 5 controls not to use the heater inside the stay 36a (S5). If the control portion 5 determines it is not that the type of the recording material P is plain paper and the basis weight is equal to or smaller than 90 gsm in S3, then the control portion 5 controls to use the heater inside the stay 36a (S6).

Based on such determination, by determining the use/non-use of the heater inside the stay 36a, it becomes possible, while maintaining the fixing performance, to reduce the power consumption.

Incidentally, in FIG. 7, etc., conditions described as “use” the heater inside the stay 36a means that it is possible to use the heater inside the stay 36a. For example, in a case in which the heater inside the stay 36a cannot be used due to other constraint matters, such as a case in which electric power usable in the entire fixing device 30 does not satisfy electric power capable of turning on the heater inside the stay 36a, it may not be used.

In addition, in FIG. 7, etc., the conditions described as “use” the heater inside the stay 36a does not necessarily need to continue to generate heat (turn on) with the maximum heating amount. For example, in a case in which the temperature of the stay 32 has reached the target temperature, temperature adjusting control by ON/OFF time division control, phase control, etc. may be performed.

In this manner, in the present Embodiment, the fixing device 30 for fixing the toner image onto the recording material P includes the endless fixing belt 31, the first heating member (pad portion) 34 which heats the fixing belt 31, the second heating member (heating roller) 37 which heats the fixing belt 31, the first heating source (heater inside the stay) 36a which heats the first heating member 34, the second heating source (heater inside the heating roller) 36b which heats the second heating member 37, the pressing member (pressing roller) 35 which forms the fixing nip portion N together with the fixing belt 31 and nips and conveys the recording material P together with the fixing belt 31 at the fixing nip portion N, and the control portion 5 which controls at least the first heating source 36a and the second heating source 36b, and the control portion 5 controls to cause the first heating source 36a not to generate the heat during the fixing operation in which the recording material P is passing through the fixing nip portion N. In the present Embodiment, the first heating member 34 and the second heating member 37 are provided on the inner surface side of the fixing belt 31. In addition, the first heating member 34 forms the fixing nip portion N together with the pressing member 35. In particular, in the present Embodiment, the first heating member 34 includes the pad (pressing pad) 33, which forms the fixing nip portion N together with the pressing member 35, and the supporting member (stay) 32, which supports the pad 33. In addition, in the present Embodiment, the thermal conductivity of the pad 33 is smaller than the thermal conductivity of the supporting member 32. In addition, in the present Embodiment, the first heating source 36a is provided between the pad 33 and the supporting member 32 (inside the hollow portion of the stay 32). In addition, in the present Embodiment, the second heating member 37 is constituted by the roller (heating roller) which stretches the fixing belt 31. In addition, in the present Embodiment, the second heating source 36b is provided inside the hollow portion of the roller. In addition, in the present Embodiment, the heat capacity of the first heating member 34 is larger than the heat capacity of the second heating member 37. In addition, in the present Embodiment, the temperature rising speed of the fixing belt 31 by the first heating member 34 when the first heating source 36a generates the heat with the maximum heating amount is slower than the temperature rising speed of the fixing belt 31 by the second heating member 37 when the second heating source 36b generates the heat with the maximum heating amount.

In addition, in the present Embodiment, in the start up period of the fixing device 30 (start up P1) from a state in which heat generation of the first heating source 36a and the second heating source 36b is stopped until the temperature of the first heating member 34 reaches the first target temperature and the temperature of the second heating member 37 reaches the second target temperature, the control portion 5 controls to cause the first heating source 36a and the second heating source 36b to generate the heat. In addition, in the present Embodiment, the first target temperature is higher than the second target temperature. In addition, in the present Embodiment, after the temperature of the first heating member 34 reaches the first target temperature and the temperature of the second heating member 37 reaches the second target temperature in the start up period, the control portion 5 controls to cause the first heating source 36a and the second heating source 36b to generate heat in the period until the print information is received (standby P2). In addition, in the present Embodiment, the control portion 5 is capable of selectively performing the operation in the first mode in which the control portion 5 controls to cause the first heating source 36a not to generate the heat and in the second mode in which the control portion 5 controls to cause the first heating source 36a to generate the heat in the period from the reception of the print information until the recording material P reaches the fixing nip portion N (pre rotation P3). In addition, in the present Embodiment, the control portion 5 controls to selectively perform the operation in the first mode and in the second mode based on the type of the recording material P. In particular, in the present Embodiment, the control portion 5 controls to perform the operation in the first mode when the basis weight of the recording material P is equal to or smaller than the predetermined value and in the second mode when the basis weight of the recording material P is larger than the predetermined value. In addition, in the present Embodiment, in any case of the first mode or the second mode being executed, when a first recording material P after the control portion 5 receives the print information reaches the fixing nip portion N, the temperature of the first heating member 34 is higher than the temperature of the second heating member 37.

In addition, in the present Embodiment, the image forming apparatus 1 includes the image forming portion 100 which forms the toner image on the recording material P, and the fixing device 30 described above which fixes the toner image formed by the image forming portion 100 onto the recording material P.

As described above, according to the present Embodiment, in the configuration provided with the plurality of heating members 34 and 37 for heating the fixing belt 31, it becomes possible, while maintaining the fixing performance, to achieve reduction in the power consumption.

### OTHER EMBODIMENTS

As described above, the present invention has been described according to the specific Embodiment, however, the present invention is not limited to the Embodiment described above.

In the Embodiment described above, the use/non-use of the heater inside the stay 36a is determined based on the print information in the pre rotation P3, however, the present invention is not limited thereto. For example, it may be configured that the heater inside the stay 36a is always used in the pre rotation P3, or is always not used. In addition, with using the print information other than the basis weight information, the determination of the use/non-use of the heater inside the stay 36a in the pre rotation P3 may be performed. For example, the determination of the use/non-use of the heater inside the stay 36a in the pre rotation P3 may be performed based on the number of prints. In this case, for example, it is possible to configure the heater inside the stay 36a not to be used in the pre rotation P3 for a job in which the number of prints is equal to or smaller than a predetermined number, and configure the heater inside the stay 36a to be used in the pre rotation P3 for a job in which the number of prints is larger than the predetermined number.

In addition, in the Embodiment described above, the fixing device 30 includes two heating members of the heating roller 37 and the stay 32 as the heating members, however, the fixing device 30 may include three or more heating members. Also in that case, it is possible to perform the control according to the Embodiment described above. That is, in that case, to a heating source, which heats a heating member having a largest heat capacity, or a heating source, which heats a heating member having a slowest speed at which the temperature of the fixing belt 31 is caused to be increased in a case of generating heat with a maximum heating amount, the same control as that for the heater inside the stay 36a in the Embodiment described above may be applied. In other words, it is sufficient to control so as not to use the heating source during the fixing operation. In addition, use/non-use of the heating source may be switched during the pre rotation. As a result, similarly to the Embodiment described above, it becomes possible, while maintaining the fixing performance, to reduce the power consumption.

In addition, in the Embodiment described above, the image forming apparatus is a color image forming apparatus, however, the present invention may also be applied to, for example, a monochrome image forming apparatus of a single color of black.

In addition, at least one of the heating members which heat the fixing belt may be provided on the outer surface side of the fixing belt.

According to the present invention, in the configuration provided with the plurality of heating members for heating the fixing belt, by controlling the heating source before the fixing operation and during the fixing operation, it becomes possible, while maintaining the fixing performance, to achieve the reduction in the power consumption.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-073789, filed Apr. 26, 2025, which is hereby incorporated by reference herein in its entirety.

What is claimed is:

1. A fixing device for fixing a toner image onto a recording material, the fixing device comprising:
an endless belt;
a heating roller disposed in an inner peripheral surface side of the belt and configured to heat the belt by a first heater provided therein;
a pressing roller in contact with an outer peripheral surface of the belt and configured to nip and convey the recording material;
a nip forming member disposed opposed to the pressing roller across the belt and configured to form a fixing nip portion;
a supporting member configured to support the nip forming member;
a second heater configured to heat the supporting member; and
a controller configured to control the first heater and the second heater,
wherein the fixing device has a start up period until the fixing device becomes a fixable state and a fixing period of performing a fixing operation, and
wherein the controller causes the first heater and the second heater to generate heat in the start up period and causes the first heater to generate the heat and the second heater not to generate the heat in the fixing period.

2. The fixing device according to claim 1, wherein the supporting member is a stay made of metal.

3. The fixing device according to claim 1, wherein a thermal conductivity of the nip forming member is smaller than a thermal conductivity of the supporting member.

4. The fixing device according to claim 1, wherein the second heater is provided between the nip forming member and the supporting member.

5. The fixing device according to claim 1, wherein the first heater is provided inside a hollow portion of the heating roller.

6. The fixing device according to claim 1, wherein a heat capacity of the nip forming member is larger than a heat capacity of the heating roller.

7. The fixing device according to claim 1, wherein a temperature rising speed of the belt by the nip forming member when the second heater generates the heat with a maximum heating amount is slower than a temperature rising speed of the belt by the heating roller when the first heater generates the heat with a maximum heating amount.

8. The fixing device according to claim 1, wherein in the start up period of the fixing device from a state in which heat generation of the first heater and the second heater is stopped until a temperature of the nip forming member reaches a first target temperature and a temperature of the heating roller reaches a second target temperature, the controller controls to cause the first heater and the second heater to generate the heat.

9. The fixing device according to claim 8, wherein the first target temperature is higher than the second target temperature.

10. The fixing device according to claim 8, wherein after the temperature of the nip forming member reaches the first target temperature and the temperature of the heating roller reaches the second target temperature in the start up period, the controller controls to cause the first heater and the second heater to generate the heat in a period until print information is received.

11. The fixing device according to claim 8, wherein the controller is capable of selectively performing an operation in a first mode in which the controller controls to cause the second heater not to generate the heat and in a second mode in which the controller controls to cause the second heater to generate the heat in a period from reception of print information until the recording material reaches the fixing nip portion.

12. The fixing device according to claim 11, wherein the controller controls to selectively perform the operation in the first mode and in the second mode based on a type of the recording material.

13. The fixing device according to claim 12, wherein the controller controls to perform the operation in the first mode when a basis weight of the recording material is equal to or smaller than a predetermined value and in the second mode when the basis weight of the recording material is larger than the predetermined value.

14. The fixing device according to claim 1, wherein the controller controls cause the first heater to generate the heat and the second heater to generate the heat in a period of post rotation after the recording material has passed through the fixing nip portion from reception of print information.

15. An image forming apparatus comprising:
an image forming portion configure to form a toner image on a recording material:
a fixing device according to claim 1, the fixing device fixing the toner image formed by the image forming portion onto a recoding material.
